(19) United States
(12) Patent Application Publication
(10) Pub. No.: US 2025/0158472 A1
(43) Pub. Date: May 15, 2025

(54) ELECTRIC MOTOR

(71) Applicant: Brose Fahrzeugteile SE & Co. Kommanditgesellschaft, Würzburg, Würzburg (DE)

(72) Inventors: Vladimir BOZICKOVIC, Pancevo (RS); Aleksa BRKIC, Pancevo (RS); Milos GVOZDEN, Belgrade (RS); Aniruddha JADHAV, Mangaon (IN); Vaibhav LANDE, Akola (IN); Shubham MORE, Pune (IN); Ajinkya VADAJE, Nashik (IN)

(21) Appl. No.: 18/944,277

(22) Filed: Nov. 12, 2024

(30) Foreign Application Priority Data
Nov. 14, 2023 (DE) 10 2023 211 310.4

(51) Int. Cl. H02K 5/06; H02K 5/02; H02K 11/33

(52) U.S. Cl. CPC H02K 5/06; H02K 5/02; H02K 11/33

(57) ABSTRACT

An electric motor is particularly suited for a radiator fan. The motor has a motor carrier with an electronics compartment for motor electronics. The electronics compartment has an electronics compartment base and a side wall projecting in the vertical direction relative to the electronics compartment base. An electronics compartment cover closes the electronics compartment. The electronics compartment cover has a channel-like receptacle for a free end of the side wall. The receptacle has an outer wall arranged on the outside of the side wall. A lug extends from the outer wall, in particular from a free end of the outer wall, counter to the vertical direction. The lug has a lug base portion and a snap-in element arranged thereon for a snap-in connection to a snap-in nose of the motor carrier.

The invention relates to an electric motor which has a motor carrier with an electronics compartment for motor electronics, and an electronics compartment cover for closing the electronics compartment.

For example DE 10 2018 200 598 A1 discloses an electric motor, the stator of which is fastened to a motor carrier. The motor carrier also has an electronics compartment for motor electronics on the side facing away from the stator, the electronics compartment being covered by means of an electronics compartment cover when assembled.

In such an electric motor, the electronics compartment cover is typically adhesively bonded onto the free end of a side wall of the electronics compartment.

In order to avoid undefined slipping of the electronics compartment cover relative to the side wall in the course of the assembly, in particular also when adhesively bonding the electronics compartment cover onto the side wall, the electronics compartment cover should be fixed.

The invention is based on the object of specifying an electric motor in which particularly suitable fixing of the electronics compartment cover on the motor carrier is implemented. The fixing is to be carried out with as little overall space and/or while saving as much material as possible.

According to the invention, this object is achieved by an electric motor having the features of claim 1. Advantageous embodiments and developments are the subject-matter of the sub-claims.

The electric motor is in particular provided and designed for a radiator fan. For example, the electric motor is provided and designed to drive a fan impeller in rotation.

The electric motor comprises a motor carrier. Expediently, a stator of the electric motor is fastened thereto and/or a bearing for a rotor shaft of a rotor of the electric motor is fastened thereto. For example, the motor carrier is arranged above the stator and the rotor in the axial direction, i.e. in the direction of an axis of rotation of the rotor. The stator expediently has a number of coils, which are wired to one another, for example according to a star or delta circuit.

The electric motor expediently comprises motor electronics. These are, for example, designed to energize the coils of the stator to generate a rotating field. To this end, the motor electronics comprise a bridge circuit, for example, which is electrically connected to the coils of the stator.

The motor carrier has an electronics compartment for motor electronics. In other words, the electronics compartment forms a receiving space for the motor electronics. For this purpose, the electronics compartment has an electronics compartment base and a side wall projecting in a vertical direction, in particular in the axial direction, relative to the electronics compartment base, in particular vertically. Preferably, the motor carrier is formed monolithically, that is to say in one piece, so that the side wall is molded onto the electronics compartment base.

The electric motor also comprises an electronics compartment cover for covering, in particular for closing, the electronics compartment. The electronics compartment cover, also designated as a cover below, has a receptacle for the free end, i.e. for the end of the side wall that faces away from the electronics compartment base. In the assembled state, the free end of the side wall is therefore arranged in the receptacle, wherein an adhesive for joining the cover to the side wall is preferably introduced into the receptacle.

The electronics compartment cover is expediently formed from an aluminum-magnesium alloy, in particular from EN AW 5754. Consequently, the electronics compartment cover is particularly resistant to corrosion. In addition, an electronics compartment cover formed from this material is comparatively resistant to bending.

Here, the receptacle is preferably formed in the manner of a channel. Therefore, this comprises a substantially U-shaped cross section, the free end of the side wall and/or the adhesive being accommodated in the region between the two parallel U legs of the U shape in the assembled state.

The receptacle preferably extends, in particular completely, along the circumference of the cover.

The receptacle has an outer wall, which is arranged on the outside of the side wall of the electronics compartment. The outer wall is thus arranged outside the receiving space enclosed by the side wall. For example, the outer wall is substantially parallel to the side wall, at least in the region of its free end, i.e. in the region of its lower end with respect to the vertical direction. If the receptacle is formed in the manner of a channel, the outer wall is formed by using that leg of the U, i.e. using that channel wall, which is arranged on the outside of the side wall.

From the outer wall of the receptacle of the electronics compartment cover, in particular from its free end, in other words from that end of the outer wall which is lower with respect to the vertical direction, in still other words from the edge of the outer wall, a lug extends counter to the vertical direction. In particular, the lug is formed monolithically on the outer wall. In summary, the lug projects counter to the vertical direction relative to the edge of the outer wall.

Expediently, the lug forms an extension of the outer wall and/or has the same thickness as the outer wall.

The lug in turn has a preferably flat (lug) base portion and a snap-in element arranged thereon, in particular protruding from the latter. The snap-in element is provided to form a snap-in connection with a snap-in nose (latching nose) of the motor carrier. In the assembled state, the snap-in element engages behind the snap-in nose of the motor carrier, forming a snap-in connection. For example, in the assembled state, the snap-in element is arranged underneath the snap-in nose with respect to the vertical direction, and the outer wall is arranged above the snap-in nose. In summary, the lug base portion forms a snap-in arm and the snap-in element forms a locking element for the snap-in connection.

Advantageously, by using such a snap-in connection, a fixing of the electronics compartment cover to the motor carrier that can be produced particularly simply is implemented for the assembly of the electric motor. The lug projecting beyond the outer wall, which engages behind the snap-in nose of the motor carrier, represents a particularly advantageous embodiment of a snap-in connection that saves overall space and material.

According to a particularly suitable embodiment, the lug has a U-shaped internal slot. In other words, a U-shaped slot, which extends completely within the area covered by the lug, that is to say does not extend as far as its edge, is introduced into the lug. In still other words, the start of the slot and the end of the slot are arranged within the lug. The internal slot is continuous in a direction at right angles to the area spanned by the lug. Particularly preferably, the U shape is open in a direction counter to the vertical direction. In other words, the two parallel U legs (vertical legs) extend in the vertical direction, wherein the U connecting leg (horizontal leg) connecting the two parallel U legs to each other is arranged on the upper end of the parallel U legs with respect to the vertical direction.

The portion of the lug comprised, that is to say enclosed, by the internal slot is inclined toward the side wall at a first angle of inclination or, alternatively, away from the side wall, so that this enclosed portion forms the snap-in element. Therefore, the portion of the lug that is arranged between the parallel U legs of the internal slot with regard to a direction along the edge of the outer wall forms the snap-in element.

In other words, the lug base portion forms an in particular flat frame, which comprises a rectangular cut-out, wherein the snap-in element is molded preferably on the side delimiting the cut-out toward the bottom with regard to the vertical direction and extends from this side at an angle toward the frame.

In still other words, the end of the snap-in element that is lower with respect to the vertical direction is preferably connected to the lug base portion, wherein the free end of the snap-in element, that is to say its upper end with respect to the vertical direction, is bent away from the lug base portion in a direction perpendicular to the plane spanned by the latter.

In summary, a part of the lug is used in a material-saving manner as a snap-in element.

According to a suitable development, the first angle of inclination, i.e. the angle between the lug base portion and the snap-in element, is between 20° and 35°, in particular between 25° and 30°. In particular, if the electronics compartment cover and thus also the lug is formed from an aluminum-magnesium alloy, in particular from EN AW 5754, it has a comparatively low elastic deformability. Given a first angle of inclination between 20° and 35°, in particular between 25° and 30°, the elastic deformation of the lug in the course of assembly is sufficiently high to form a secure rear grip.

According to a suitable embodiment, the lug, in particular its lug base portion, i.e. that portion of the lug on which the snap-in element is arranged, spans a plane which is oriented parallel to the free end of the outer wall, in particular parallel to that portion of the free end of the outer wall from which the lug extends. In this way, the installation space needed for the snap-in connection is comparatively small.

According to a preferred embodiment, the lug base portion of the lug is inclined with respect to the vertical direction by a second angle of inclination. Preferably, with respect to the vertical direction, the lower end of the lug is inclined away from the side wall of the electronics compartment.

Expediently, the second angle of inclination is between 0.1 and 5°, in particular between 0.5 and 2.0°, preferably 1°.

In this way, the deformation necessary in the course of the assembly is reduced so that, even when the cover is formed from comparatively inelastically deformable material such as, for example, from an aluminum-magnesium alloy, in particular from EN AW 5754, secure retention is implemented.

According to a suitable embodiment, the snap-in nose is formed by using the side wall. In particular, the snap-in nose is molded onto the side wall and/or formed by using the side wall. For instance, on the outer side the side wall has an undercut, i.e. a cut-out, into which the snap-in element engages to form the snap-in connection. In this embodiment, the snap-in element is expediently bent toward the side wall. Advantageously, in this variant functional integration of the snap-in nose into the side wall is implemented.

According to an embodiment that is an alternative thereto, the snap-in nose is arranged at a distance from and expediently parallel to the side wall. In the assembled state, the lug is arranged between the side wall and the snap-in nose, therefore projects between the side wall and the snap-in nose. In this embodiment, the snap-in element is expediently bent away from the side wall.

According to a suitable development which can be used for both variants, the side of the snap-in nose that faces the lug is inclined with respect to the vertical direction H at a third angle of inclination y. This side in particular forms a guide surface for the snap-in element in the course of the assembly, that is to say as the electronics compartment cover is plugged on. Therefore, during the assembly, the snap-in nose is pressed against this guide surface and slides on the latter counter to the vertical direction, the lug being deformed continuously.

Particularly preferably, the third angle of inclination, that is to say the angle between the vertical direction and the side of the snap-in nose that faces the lug, is between 5° and 20°, in particular between 7° and 15°. In this way, during the assembly in particular the formation of the snap-in connection is made easier, in particular for covers of comparatively inelastically deformable material such as, for example, of an aluminum-magnesium alloy, in particular from EN AW 5754.

Exemplary embodiments of the invention will be explained below in more detail with reference to a drawing, in which:

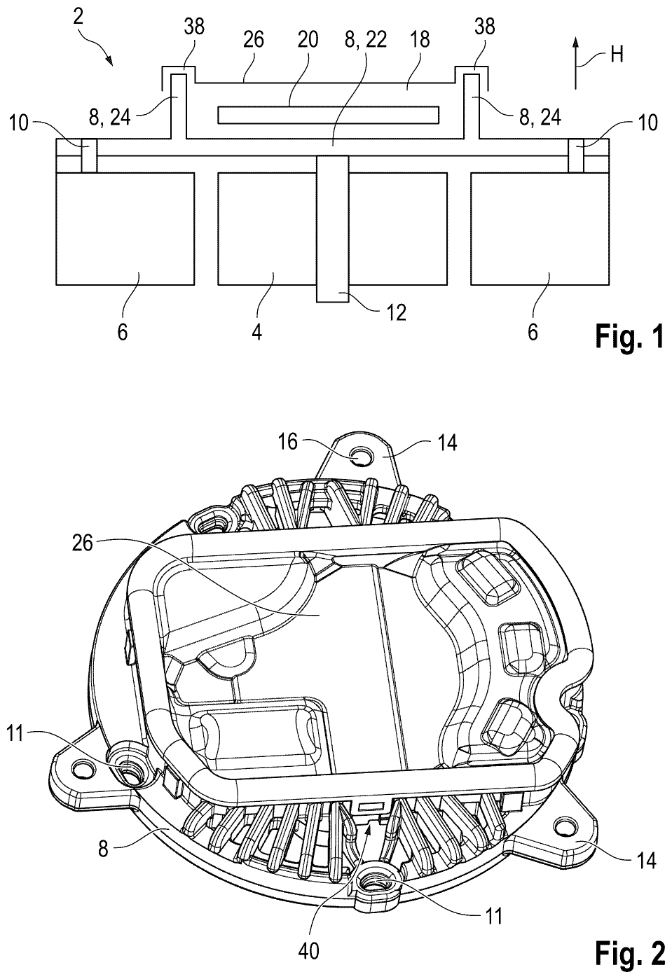

FIG. 1 shows, schematically, a cross section of an electric motor which has a motor carrier, wherein the motor carrier forms an electronics compartment for motor electronics, and wherein the electronics compartment is closed by an electronics compartment cover,

FIG. 2 shows a perspective view of a first variant of the motor carrier, wherein the side wall of the electronics compartment has a snap-in nose, behind which a snap-in element of a lug of the electronics compartment cover engages, forming a snap-in connection,

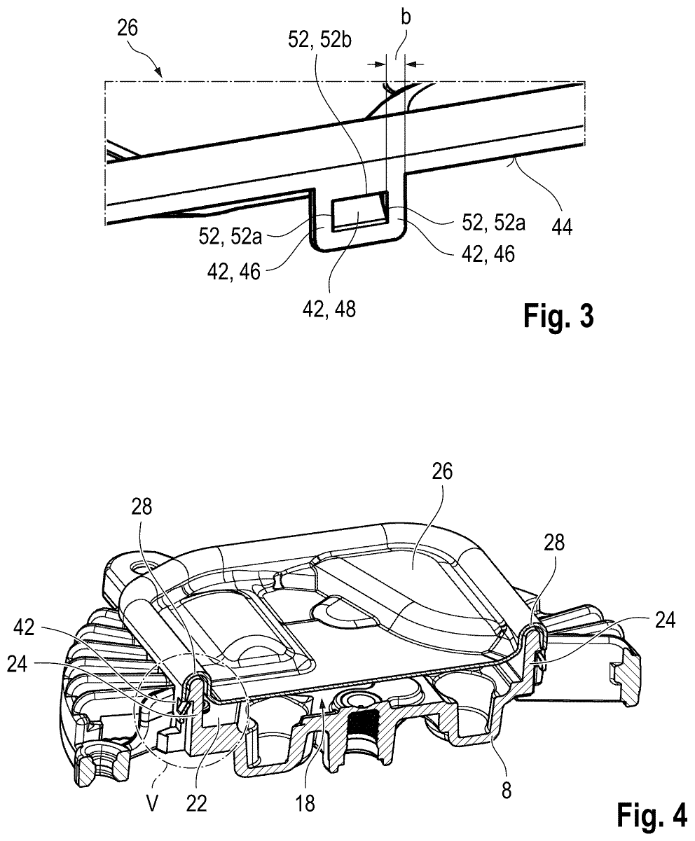

FIG. 3 shows a top view of the lug of the electronics compartment cover, wherein a U-shaped internal slot is introduced into the latter to form a snap-in element,

FIG. 4 shows perspectively, in a sectional illustration, a cross section through the motor carrier and through the electronics compartment cover of FIG. 2 with a section plane through the snap-in connection,

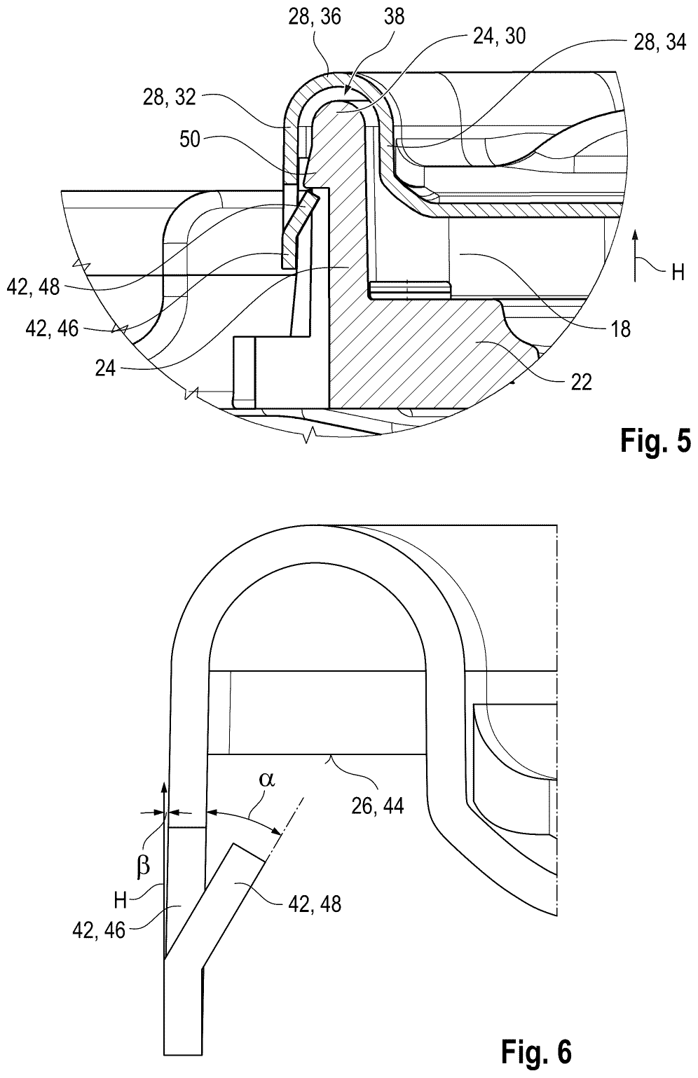

FIG. 5 shows the region V of FIG. 4 on an enlarged scale in a top view,

FIG. 6 shows a cross section of the electronics compartment cover with the section plane through the lug, on an enlarged scale,

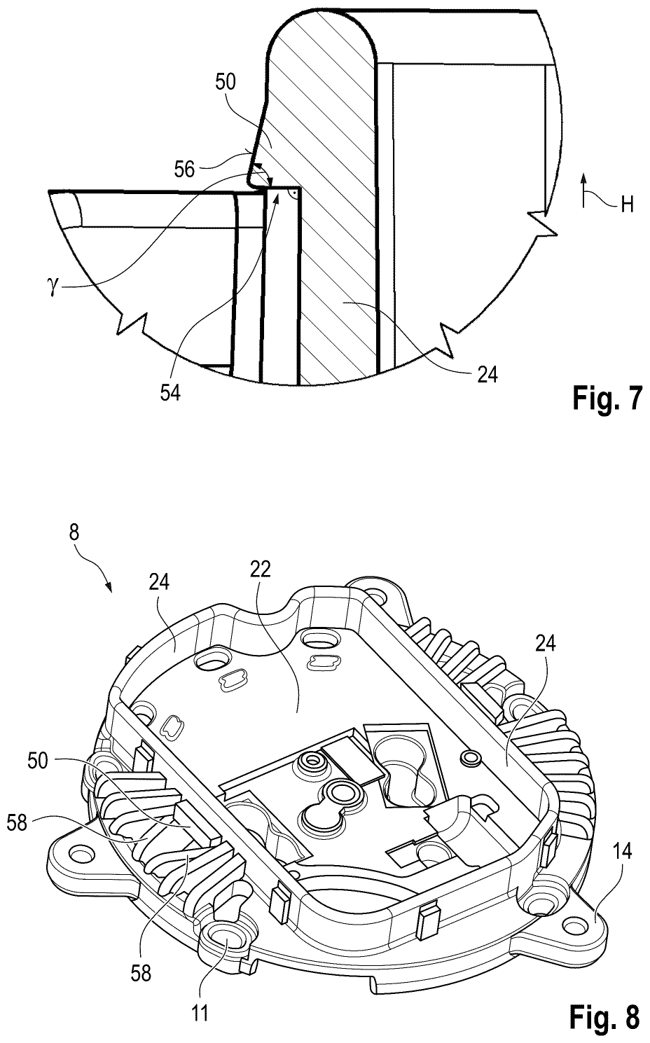

FIG. 7 shows a cross section of the snap-in nose of the side wall of the electronics compartment on an enlarged scale,

FIG. 8 shows a perspective view of a second variant of the motor carrier, wherein the snap-in nose is at a distance from the side wall of the electronics compartment,

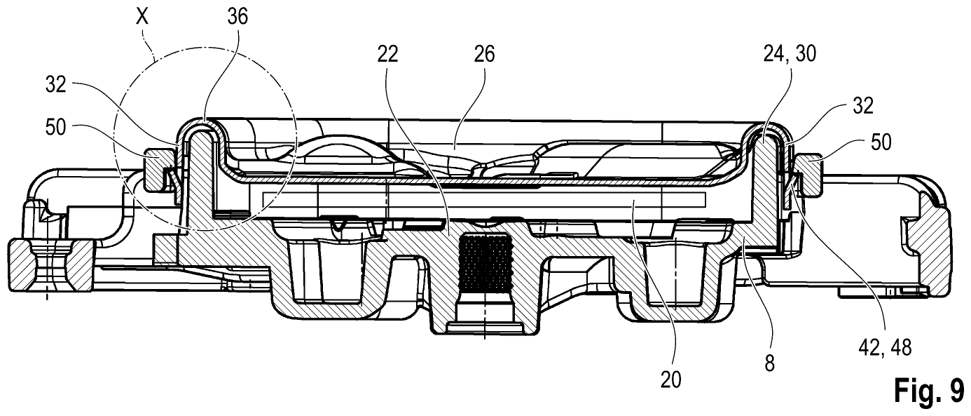

FIG. 9 shows perspectively, in a sectional illustration, a cross section through the motor carrier of FIG. 7 and the electronics compartment cover with a section plane through the snap-in connection, and

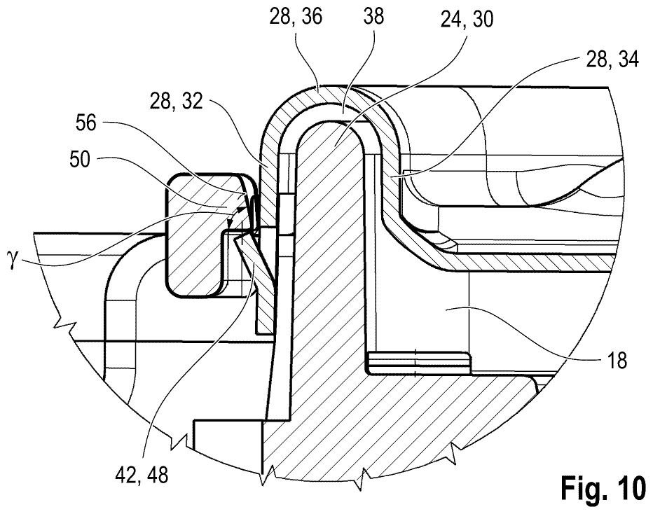

FIG. 10 shows the region X of FIG. 9 on an enlarged scale in a top view.

Mutually corresponding parts and sizes are always provided with the same designations in all the figures.

An electric motor 2, formed as an internal-rotor motor by way of example, which is provided in particular for a radiator fan, is illustrated in FIG. 1.

The electric motor 2 comprises a rotor 4 and a stator 6, wherein the rotor 4 is connected to a fan impeller in a manner not illustrated in detail and drives the latter in rotation. According to the exemplary embodiment illustrated here, the rotor 4 is arranged radially inside the stator 6. In other words, the electric motor 2 is formed as an internal-rotor motor.

The electric motor 2 further comprises a motor carrier 8, to which the stator 6 is fastened. For example, a plastic overmolding of a laminated core of the stator has dome-like extensions 10 for this purpose, which are received in corresponding receptacles 11 in the motor carrier 8 and, for example, are hot-staked there. In a manner not specifically illustrated, a bearing for the rotary shaft 12 of the rotor 4 is fastened to the motor carrier.

The motor carrier 10 further comprises a flange 14 with a screw lead-through 16 for fastening to a frame.

The motor carrier 8 is arranged over the stator 6 in the axial direction, i.e. along an axis defined by the rotary shaft 12. The motor carrier 8 is formed monolithically, i.e. in one piece. For example, the motor carrier 8 is a cast part.

The motor carrier 8 forms an electronics compartment 18, i.e. a receiving space for motor electronics 20. By means of the motor electronics 20, coils of the stator 6 are energized in order to generate a rotating field, so that the rotor is set rotating. To this end, the motor electronics 20 expediently comprise a printed circuit board and/or a bridge circuit, which is electrically connected to the coils.

To form the electronics compartment, the motor carrier 8 has an electronics compartment 18, an electronics compartment base 22 and a side wall 24 projecting vertically relative to the electronics compartment base 22 in the vertical direction H which, in this embodiment of the electric motor 2, is oriented parallel to the axial direction. The side wall 48 surrounds the electronics compartment 18 in the manner of a frame.

An electronics compartment cover 26 of the electric motor 2 covers the electronics compartment 18. The electronics compartment cover 26 has on its circumference a receptacle 28 for the free end 30 of the side wall 24. The receptacle 28 is formed here in the manner of a channel. Thus, the receptacle 28 has a U-shaped cross section. Two channel walls 32, 34 are formed on the inner side and on the outer side of the side wall 24 in the region of the free end 30. A channel base 36 is arranged above the free end in the vertical direction and connects the two channel walls 32, 34. In summary, the channel-like receptacle 28 encloses the free end 30 of the side wall 24. The channel wall 32 arranged on the outer side, that is to say on the side of the side wall 24 that faces away from the electronics compartment 18, is also designated as an outer wall 32 here and below.

The free end 30 of the side wall 24 facing away from the electronics compartment base 22 is therefore received in the receptacle 28 and is adhesively bonded to the electronics compartment cover 26 there, in particular in a fluid-tight manner. In other words, a gap 38 formed between the free end 30 of the side wall 24 and the receptacle 28 is provided with adhesive (not shown), so that the gap 38 is closed in a fluid-tight, in particular airtight and water-tight, manner.

For the purpose of fixing during the adhesive bonding, the electronics compartment cover 26 is joined to the motor carrier by means of at least one snap-in connection (snap-in closure) 40 (not shown in FIG. 1). The two snap-in connections are configured identically. The electronics compartment cover 26 is formed, for example, from an aluminum-magnesium alloy, in particular EN AW 5754.

The first variant of the snap-in connection is illustrated in FIGS. 2 to 6, and a second variant of the snap-in connection is illustrated in FIGS. 8 to 10. In both variants, two snap-in connections 40 are made which are formed analogously to each other, i.e. identically, by way of example.

In both variants, a lug 42 extends from the outer wall 32, i.e. from the outer channel wall 32 of the receptacle, in a direction counter to the vertical direction H. Starting from the free end 44 of the outer wall 32, specifically from the edge of the latter, the lug 42 extends and protrudes in a direction counter to the vertical direction H. Therefore, the lug 42 continues the outer wall 32 counter to the vertical direction H. In particular, the lug 42 and the outer wall 32 have the same thickness, i.e. material thickness.

Furthermore, it is common to both variants that the lug 42 has a lug base portion 46 which is connected to the outer wall, and a snap-in element 48 arranged on the lug base portion 46. To form the snap-in connection, the snap-in element 48 engages behind a snap-in nose 50 of the motor carrier 8 that is arranged outside the electronics compartment 18. The snap-in element 48 is arranged under the snap-in nose 50 with respect to the vertical direction H and, if appropriate, is braced against the latter.

In both variants, the snap-in element 48 is also formed as a result of the fact that the lug 42 has an internal slot with a U shape that is open downward (with respect to the vertical direction H). The internal slot is continuous in a direction at right angles to the side wall 24, so that that portion of the lug 42 which is bordered by the internal slot can be bent away from the remaining area of the lug.

The internal slot therefore has two vertical slots 52a extending parallel to the vertical direction H and a horizontal slot 52b oriented at right angles thereto and connecting the two vertical slots at their upper end (with respect to the vertical direction H).

In other words, the lug base portion 46 forms an in particular flat frame which encloses a rectangular cut-out. The snap-in element 48 is molded onto the side of the frame that delimits the cut-out toward the bottom with respect to the vertical direction H. A width b of the frame is, for example, 2 mm.

In still other words, the lower end of the snap-in element 48 with respect to the vertical direction H is connected to the lug base portion 46, wherein the free end of the snap-in element 48, that is to say its upper end with respect to the vertical direction H, is bent away from the lug base portion 46 in a direction at right angles to the plane spanned by the latter.

The lug base portion 46 of the lug 42 only spans a plane which is oriented parallel to the free end 44 of the outer wall 32.

In the first variant, see FIGS. 2 to 6, the snap-in element 48 is bent toward the side wall 24, thus inclined relative to the same. In other words, the snap-in element 48, in particular its free end, projects out of the plane spanned by the lug base portion 46 toward the side wall 24. A first angle of inclination a between the lug base portion 46 and the snap-in element 48 is between 20° and 35°, preferably between 25° and 30°, 29° according to the example illustrated here.

According to this first variant, the snap-in nose 50 is arranged on the side wall 24 or formed by the latter. The angle between the underside 54 of the snap-in nose 50 and the vertical direction H or the outer side of the side wall 24 is expediently a right angle.

The snap-in nose 50 has a guide surface for the snap-in element 48, along which the snap-in element 48 slides counter to the vertical direction H in the course of the assembly, the snap-in element 48 being correspondingly (elastically) deformed. This guide surface, i.e. the side 56 of the snap-in nose 50 which, in the assembled state, faces the lug 42, in particular the lug base portion 46 of the same, is inclined counter to the vertical direction H by a (third) angle of inclination. The third angle of inclination y is between 5° and 20°, in particular between 7° and 15°. The upper end of the snap-in nose 50 is spaced further from the lug base portion 46 than its lower end. Thus, the lower end of the snap-in nose 50 projects further away from the side wall than its upper end. In still other words, the snap-in nose 50 tapers in the vertical direction H.

In summary, the snap-in element 48 projects toward the side wall 24 and engages behind the snap-in nose 50, forming the snap-in connection 40.

For the second variant, see FIGS. 8 to 10, the explanations presented above relating to the first variant apply in an analogous way, with the exception of the following.

In this second variant, the snap-in nose 50 is at a distance from the side wall 24. For example, this is fastened to ribs 58 of the motor carrier 8. When the electronics compartment cover 26 is assembled on the electronics compartment 18, the lug 42 projects between the side wall 24 and the snap-in nose 50. Therefore, in the course of the assembly, the lug 42 is plugged in between the side wall 24 and the snap-in nose 50.

The snap-in element 48 is bent away from the side wall 24, i.e. towards the snap-in nose 50, in other words bent away from the electronics compartment. In the assembled state, the snap-in element 48 engages behind the snap-in nose 50, forming the snap-in connection 40.

In a manner analogous to the first variant, the snap-in nose 50 comprises a guide surface, which is formed by the side 56 of the snap-in nose 50 which, in the assembled state, faces the lug base portion 46, thus the side wall 24. Here, the third angle of inclination γ, i.e. the angle between the side 56 and the vertical direction H, is between 5° and 20°, in particular between 7° and 15°, 10° according to the example illustrated here. The upper end of this side 56 in the vertical direction H is inclined away from the side wall 24. Therefore, a distance between this side 56 and the side wall 24 is greater in the vertical direction H.

The first angle of inclination a between the lug base portion 46 and the snap-in element 48 in this second variant is likewise between 20° and 35°, preferably between 25° and 30°, 25° according to the example illustrated here.

In both variants, the lug base portion 46 of the lug 42 is inclined counter to the vertical direction H by a second angle of inclination β. The second angle of inclination β is between 0.1 and 5°, in particular between 0.5 and 2.0°, 1° according to the exemplary embodiment illustrated here. The lower end of the lug with respect to the vertical direction H is inclined away from the side wall 24.

The invention is not restricted to the exemplary embodiments described above. Instead, within the scope of the claims, other variants of the invention can also be derived by those skilled in the art without departing from the subject-matter of the invention. In particular, all the individual features described in connection with the exemplary embodiments and/or in the claims can also be combined with one another in another way without departing from the subject-matter of the invention.

### LIST OF DESIGNATIONS

2 Electric motor
4 Rotor
6 Stator
8 Motor carrier
10 Extension
11 Receptacle of the motor carrier
12 Rotor shaft
14 Flange
16 Screw lead-through
18 Electronics compartment
20 Motor electronics
22 Electronics compartment base
24 Side wall
26 Electronics compartment cover
28 Receptacle
30 Free end of the side wall
32 Outer channel wall/outer wall
34 Inner channel wall
36 Channel base
38 Gap
40 Snap-in connection
42 Lug
44 Free end of the outer wall/channel wall
46 Lug base portion
48 Snap-in element
50 Snap-in nose
52 Internal slot
52a Vertical slot
52b Horizontal slot
54 Underside
56 Side of the snap-in nose
58 Rib
B Width
H Vertical direction
α First angle of inclination
β Second angle of inclination
γ Third angle of inclination

1-9. (canceled)

10. An electric motor, comprising:
a motor carrier formed with an electronics compartment for motor electronics, the electronics compartment having an electronics compartment base and a side wall projecting in a vertical direction relative to said electronics compartment base;
an electronics compartment cover configured for closing said electronics compartment;
said electronics compartment cover having a channel-shaped receptacle for receiving a free end of said side wall of said electronics compartment, said receptacle having an outer wall arranged on an outside of said side wall;
a lug extending from said outer wall, counter to the vertical direction; and
said lug having a lug base portion and a snap-in element arranged thereon for a snap-in connection with a snap-in nose of said motor carrier.

11. The electric motor according to claim 10, wherein said lug extends vertically from a free end of said outer wall of said receptacle.

12. The electric motor according to claim 10, wherein said lug is formed with a U-shaped internal slot, and wherein a portion of said lug that is enclosed by said internal slot is inclined toward or away from said side wall at a first angle of inclination, forming said snap-in element.

13. The electric motor according to claim 12, where said first angle of inclination lies between 20° and 35°.

14. The electric motor (2) according to claim 13, where said first angle of inclination lies between 25° and 30°.

15. The electric motor according to claim 10, where said lug base portion of said lug spans a plane which is oriented parallel to a free end of said outer wall of said receptacle.

16. The electric motor according to claim 10, wherein said lug base portion of said lug is inclined with respect to the vertical direction at a second angle of inclination lying between 0.1 and 5°.

17. The electric motor according to claim 16, wherein said second angle of inclination lies between 0.5 and 2.0°.

18. The electric motor according to claim 16, wherein said second angle of inclination is 1°.

19. The electric motor according to claim 10, wherein said snap-in nose is formed by said side wall of said electronics compartment.

20. The electric motor according to claim 10, wherein said snap-in nose is disposed at a distance from said side wall, and wherein said lug projects between said side wall and said snap-in nose.

21. The electric motor according to claim 10, wherein a side of said snap-in nose that faces said lug forms a guide surface for assembling the snap-in element and is inclined with respect to the vertical direction at a third angle of inclination.

22. The electric motor according to claim 21, wherein said third angle of inclination lies between 5° and 20°.

23. The electric motor according to claim 22, wherein said third angle of inclination lies between 7° and 15°.

24. The electric motor according to claim 10 configured as a motor for a radiator fan.

25. The electric motor according to claim 10, wherein said electronics compartment cover is formed from an aluminum-magnesium alloy.

26. The electric motor according to claim 25, wherein said electronics compartment cover is formed from EN AW 5754.
